(19) United States
(12) Patent Application Publication
(10) Pub. No.: US 2003/0104920 A1
(43) Pub. Date: Jun. 5, 2003

(54) SiO2 shaped body which is vitrified in partial regions or completely, process for its production and use

(75) Inventors: Fritz Schwertfeger, Muehldorf (DE); Holger Szillat, Emmerting (DE); Jens Guenster, Clausthal-Zellerfeld (DE); Sven Engler, Clausthal-Zellerfeld (DE); Juergen Heinrich, Clausthal-Zellerfeld (DE)

Correspondence Address: BROOKS & KUSHMAN, 1000 TOWN CENTER 22ND FL, SOUTHFIELD, MI, 48075

(73) Assignee: Wacker-Chemie GmbH, Munich (DE)

(21) Appl. No.: 10/302,249

(22) Filed: Nov. 22, 2002

(30) Foreign Application Priority Data
Nov. 29, 2001 (DE) 101 58 521.7

(51) Int. Cl. C03C 3/06; C04B 38/00

(52) U.S. Cl. 501/54; 501/80

(57) ABSTRACT

A process for producing an SiO₂ shaped body which is vitrified in a partial region or completely, in which process an amorphous, porous SiO₂ preform is sintered or vitrified by contactless heating by means of laser radiation, by means of which contamination of the SiO₂ shaped body with foreign atoms is avoided.

### BACKGROUND OF THE INVENTION

1. Field of the Invention

The invention relates to an SiO₂ shaped body which is vitrified in whole or in part, to a process for its production, and to its use.

2. Background Art

Porous, amorphous SiO₂ shaped bodies are used in many technical fields. Examples which may be mentioned include filter materials, thermal insulation materials, and heat shields.

Furthermore, a great variety of fused silica materials can be produced from amorphous, porous SiO₂ shaped bodies by means of sintering and/or fusing. High-purity porous SiO₂ shaped bodies can be used, for example, as preforms for glass fibers or optical fibers. Furthermore, in this way it is also possible to produce crucibles for pulling single crystals, in particular silicon single crystals.

Known methods for sintering and/or fusing silica materials include furnace sintering, zone sintering, arc sintering, contact sintering, and sintering using hot gases or by means of plasma. In these methods, the silica materials to be sintered and/or fused are heated by transfer of thermal energy or thermal radiation. If the fused silica materials produced in this manner are to have extremely high purity with regard to foreign atoms, the use of hot gases or hot contact surfaces leads to undesirable contamination of the silica material with foreign atoms.

Therefore, in principle, contamination with foreign atoms can only be reduced or avoided by using non-thermal, contactless heating by means of thermal radiation.

A process known from the prior art is microwave sintering. However, absorption of microwave radiation by high-purity SiO₂ silica materials is extremely low. Therefore, a process of this type is highly inefficient and entails extremely high costs. A further drawback of this process is that partial, locally delimited and accurately defined vitrification of the silica material is not possible, since the microwave radiation is only available in highly unfocussed form.

### SUMMARY OF THE INVENTION

It is an object of the present invention to provide a process for producing an SiO₂ shaped body which is vitrified in whole or in part, wherein an amorphous, porous SiO₂ preform is sintered or vitrified by contactless heating by means of radiation, and during this step contamination of the SiO₂ shaped body with foreign atoms is avoided. This and other objects are achieved by using a laser beam as the source of vitrifying radiation.

### BRIEF DESCRIPTION OF THE DRAWINGS

FIG. 1 illustrates one embodiment of the process of the present invention.

FIG. 2 illustrates sintering and/or vitrification of the inner surface of a crucible.

FIG. 3 is a photograph of a section of a fused silica crucible produced in accordance with one embodiment of the process of the invention.

### DETAILED DESCRIPTION OF THE PREFERRED EMBODIMENTS

Thus, the subject invention pertains to the use of a laser beam to supply irradiation to a silica preform to sinter and/or vitrify a preform in whole or in part, i.e., to a selected depth, over selected portions of the preform, or any combination thereof. The area and depth of vitrification is controlled by controlling the exposure of the preform to the laser energy. To accomplish this result, the laser beam direction and/or intensity may be controlled, and/or the orientation of the preform may be controlled, as described herein.

The laser preferably has a beam with a wavelength which is greater than the edge of the absorption spectrum of the vitreous silica, i.e., 4.2 μm. Particularly preferred is the use of a CO₂ laser with a beam having a wavelength of 10.6 μm. Thus, all commercially available CO₂ lasers are suitable for use in the process of the invention. However, other lasers emitting energy with a wavelength which is absorbed by silica are suitable as well.

In the context of the present invention, an SiO₂ preform is to be understood as meaning a porous, amorphous silica shaped body which is produced from amorphous SiO₂ particles (vitreous silica) by shaping steps. Such amorphous silica and steps for shaping are generally known. In principle, for example, all SiO₂ preforms which are known from the prior art are suitable. Their production is described, for example, in patents or publications EP 705 797, EP 318 100, EP 653 381, DE-A 22 18 766, GB-B 2 329 893, JP 5294610, and U.S. Pat. No. 4,929,579. SiO₂ preforms whose production is described in DE-A1 19943103 are particularly suitable. The SiO₂ preform is preferably in the form of a crucible.

It is preferable to irradiate the inner side and the outer side of the SiO₂ preform with a laser beam with a focal spot diameter of at least 2 cm and in this manner to sinter or vitrify the preform. The irradiation is preferably carried out using a radiation power density of 50 W to 500 W per square centimeter, more preferably from 100 to 200 W/cm², and most preferably from 130 to 180 W/cm². The irradiation preferably takes place uniformly and continuously on the inner and outer sides of the SiO₂ preform. However, only selected portions, i.e., only the inner side or a portion thereof may be irradiated as well.

The uniform, continuous irradiation of the inner side and/or outer side of the SiO₂ preform for sintering or vitrification can, in principle, be carried out using movable laser optics and/or a corresponding movement of the crucible in the laser beam.

The movement of the laser beam can be facilitated by all methods which are known to those skilled in the art, for example by means of a beam-guidance system which allows movement of the laser focus in all directions. The movement of the preform in the laser beam can likewise be carried out using all methods which are known to the person skilled in the art, for example by means of robotics. Furthermore, a combination of the two movements is possible.

According to the invention, a closed, pore-free, bubble-free and crack-free amorphous SiO₂ surface is produced during the sintering or vitrification of the preform. To achieve this, the amorphous SiO₂ is sintered or fused by absorption of the laser radiation. The thickness of the vitrified inner side and/or outer side is controllable at each location by the control of laser power applied to these locations. It is preferable for the vitrification of the respective side(s) to have a thickness which is as uniform as possible.

On account of the geometry of the SiO₂ preform, it may be the case that the beam of the laser does not always impinge on the preform surface at a constant angle during the irradiation of the preform. Since the absorption of the laser radiation is angle-dependent, the result is that the thickness of the vitrification is not uniform. In such cases, to ensure that vitrification is as uniform as possible, it is preferable for one or more of the process variables, laser power, displacement path, displacement rate, and/or laser focus, to be adapted accordingly during the laser irradiation of the preform.

The vitrification or sintering of the surface of the SiO₂ preform takes place at temperatures of between 1000 and 2500° C., preferably between 1300 and 1800° C., and most preferably between 1400 and 1500° C.

Heat conduction from the hot surface into the shaped body allows partial to complete sintering of the SiO₂ shaped body beyond the vitrified inner layer and/or outer layer to be achieved at temperatures of over 1000° C.

A further object of the present invention is to provide a process which allows locally delimited, defined vitrification or sintering of a SiO₂ preform. This object may be achieved by irradiating only the inner side or only the outer side of the porous, amorphous SiO₂ preform over the surface using a laser, thus sintering or vitrifying only selected portions of the preform. Parameters and procedures for this embodiment preferably correspond to those previously described, except that only one side of the shaped body is irradiated. According to this embodiment of the invention, in this way it is possible for shaped bodies to be vitrified on one side.

On account of the very low thermal conductivity of the vitreous silica, the process of the invention can be used to produce a very sharply defined interface between vitrified and unvitrified regions in the SiO₂ shaped body. This allows preparation of SiO₂ shaped bodies with a defined sintering gradient. The invention therefore also relates to an SiO₂ shaped body which is completely vitrified on the inner side and is open-pored on the outer side, and to an SiO₂ shaped body which is completely vitrified on the outer side and is open-pored on the inner side. An SiO₂ shaped body which is completely vitrified on the inner side and is open-pored on the outer side is preferably a vitreous silica crucible for pulling silicon single crystals using the CZ process. Thus, preferred preforms comprise a hollow body having an opening therein.

A further advantage of the process according to the invention is the defined radiation direction. On account of the pronounced parallelism of the laser radiation, it is possible to increase the distance between beam source and specimen almost to any desired extent. This allows the irradiation of the material being sintered without the risk of contamination. Furthermore, the ability to focus the laser allows a very high local energy density to be achieved. Crystallization of the vitreous silica is suppressed by the extreme temperature profile in the SiO₂ preform during the process.

Since, in the case of inner-side vitrification of a preform in crucible form, there is no shrinkage of the crucible outer side, production of near net shape crucibles is facilitated. An internally vitrified, vitreous glass crucible is preferably used to pull single crystals using the CZ process.

The internally vitrified, externally open-pored amorphous vitreous glass crucibles are preferably also impregnated in the outer region with substances which cause or accelerate crystallization of the outer regions during the subsequent CZ process. Substances which are suitable for this purpose and impregnation methods are known in the prior art and are described, for example, in DE 10156137.

In the text which follows, the invention is described in greater detail with reference to examples. These examples should not be construed as limiting the scope of the invention in any way.

### EXAMPLE 1

### Production of a Porous, Amorphous SiO₂ Preform in Crucible Form

The production of a silica preform was carried out on the basis of the process described in DE-A1 19943103. High-purity fumed and fused silica was dispersed homogeneously, without bubbles and without metal contamination, in twice-distilled H₂O in vacuo with the aid of a plastic-coated mixer. The dispersion produced in this way had a solids content of 83.96% by weight (95% fused and 5% fumed silica). The dispersion was shaped into a 14″ crucible in a plastic-coated outer mold by means of the roller process which is in widespread use in the ceramics industry. After drying for one hour at a temperature of 80° C., it was possible to demold the crucible, which it was then possible to fully dry at approximately 200° C. over the course of 24 hours. The dried, open-pored crucible preform had a density of approx. 1.62 g/cm³ and a wall thickness of 9 mm.

### EXAMPLE 2

### Carrying Out the Process According to the Invention Using the Preform from Example 1

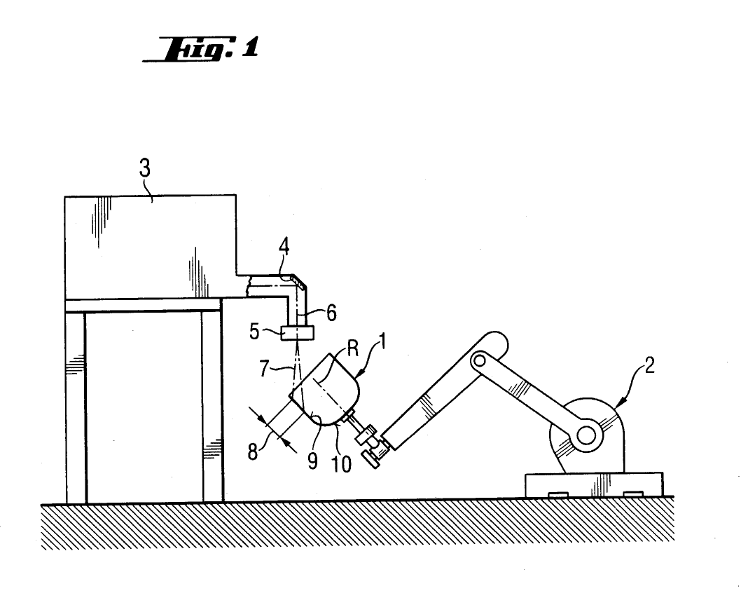

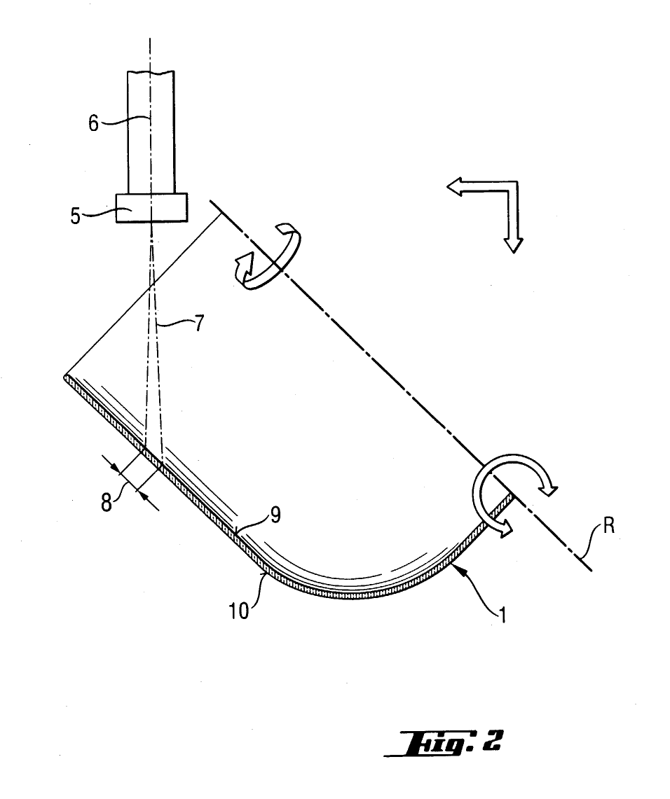

The 14″ crucible preform 1 from Example 1 was irradiated by means of an ABB robot 2 (model IRB 2400) in the focus of a CO₂ laser 3 (model TLF 3000 Turbo) with 3 kW beam power, as shown in FIGS. 1 and 2.

The laser 3 was equipped with a rigid beam guidance system, and all degrees of freedom of movement were provided by the robot carrying the preform. In addition to a diverting mirror 4, which diverts the radiation emerging horizontally from the laser resonator into a vertical direction, beam guidance was provided by optics 5 in order to widen the primary beam 6. The primary beam had a diameter of 16 mm. After the parallel primary beam had passed the widening optics 5, the result was a divergent beam path 7. The focal spot 8 on the 14″ crucible had a diameter of 50 mm at a distance of approx. 450 mm between optics 5 and crucible 1 (cf. FIG. 1). The robot 2 was controlled using a program adapted to the crucible geometry. On account of the rotationally symmetrical form (axis of rotation R) of the crucible 1, it was possible to restrict the degrees of freedom of the movement to one plane plus two axes of rotation (cf. FIG. 2). With the crucible rotating (angular velocity 0.15°/s), first of all the upper edge of the crucible was covered by the laser over an angular range of 375°. Then, the laser passed over the remainder of the inner surface 9 of the crucible 1 in the form of a helix. The rotational speed and speed of advance of the crucible on an axis from the crucible 1 edge to the center was accelerated in such a way that the area covered per unit of time was constant. The radiation was carried out at 150 W/cm².

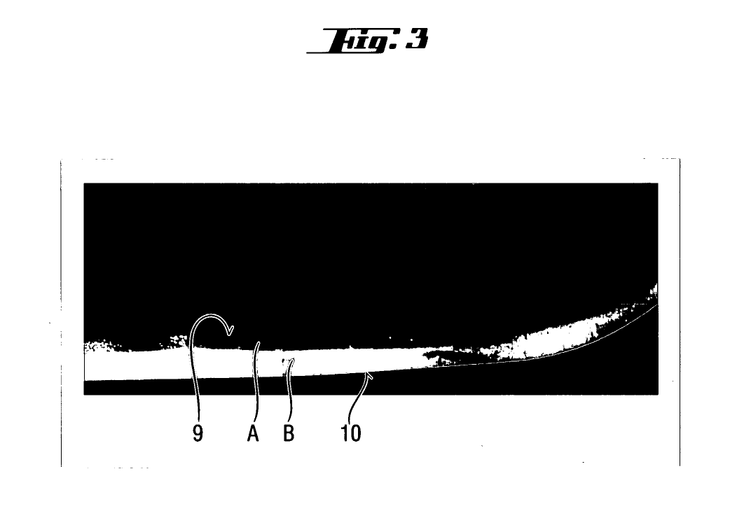

In the same process step, in addition to the vitrification of the preform surface, the SiO₂ shaped body was partially sintered (layer B, FIG. 3) as a result of conduction of heat from the hot inner surface 9 into the interior of the shaped body. After the laser irradiation, the SiO₂ crucible 1 has been vitrified (layer A) without pores, bubbles or cracks over a thickness of 3 mm starting from the inner surface, while its original external geometry was maintained (cf. FIG. 3).

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A process for the entire or partial vitrification of an amorphous, porous silica shaped body while minimizing contamination of the silica by foreign atoms, said process comprising:
providing a preform of amorphous, porous silica;
providing a source of laser radiation of a wavelength absorbable by silica;
impinging said laser radiation onto said amorphous, porous silica preform such that sintering and/or vitrification of the silica occurs in a region of impingement of said laser radiation; and
moving said amorphous, porous silica preform relative to said source of laser radiation such that portion(s) of said amorphous, porous preform not initially sintered and/or vitrified by said laser irradiation are sintered and/or vitrified.

2. The process of claim 1, wherein the laser has a beam with a wavelength which is greater than 4.2 μm.

3. The process of claim 1, wherein the laser is a CO₂ laser with a beam having a wavelength of about 10.6 μm.

4. The method of claim 1, wherein the porous, amorphous silica preform is in the form of a crucible.

5. The method of claim 1, wherein an inner side and an outer side of the silica preform are irradiated by a laser beam with a focal spot diameter of at least 2 cm and said inner and outer sides are sintered and/or vitrified.

6. The process of claim 5, wherein the step of moving said silica preform relative to said laser radiation is performed by moving said focal spot by altering the direction of said laser beam.

7. The process of claim 5, wherein the step of moving said silica preform relative to said laser radiation is performed by robotically altering the position and/or orientation of said silica preform.

8. The process of claim 5, wherein the step of moving said silica preform with respect to said laser radiation is performed both by altering the direction of said laser beam and by robotically altering the position and/or orientation of said silica preform.

9. The method of claim 1, wherein irradiation of the inner and/or outer sides of the preform is uniform and continuous.

10. The method of claim 1, wherein the vitrification and/or sintering of the surface of the silica preform takes place at temperatures of between 1000 and 2500° C.

11. The method of claim 1, wherein the vitrification and/or sintering of the surface of the silica preform takes place at temperatures of between 1300 and 1800° C.

12. The method of claim 1, wherein the vitrification and/or sintering of the surface of the silica preform takes place at temperatures of between 1400 and 1500° C.

13. The method of claim 1, wherein the laser irradiation impinges upon said preform with an energy of 50 W to 500 W per square centimeter.

14. The method of claim 1, wherein the laser irradiation impinges upon said preform with an energy of 100 W to 200 W per square centimeter.

15. The method of claim 1, wherein predetermined locally delimited sintering and/or vitrification of said preform is conducted by irradiating only an inner surface or only an outer surface of said preform.

16. The method of claim 15, wherein said preform is a hollow body having an opening therein.

17. The method of claim 16, wherein said hollow body is a crucible preform.

18. The method of claim 17, wherein said crucible preform is a crucible preform suitable for sintering and/or vitrifying to a crucible suitable for pulling silicon single crystals by the CZ process.

19. A silica shaped body, which is completely vitrified on an inner side and is open-pored on an outer side.

20. The silica shaped body of claim 19, which is a vitreous silica crucible for pulling silicon single crystals using the CZ process.

21. A silica shaped body, which is completely vitrified on an outer side and is open-pored on an inner side.
